(19) United States
(12) Patent Application Publication
(10) Pub. No.: US 2025/0297805 A1
(43) Pub. Date: Sep. 25, 2025

(54) HEAT PIPE DRYER WITH OSCILLATING HEAT PIPE ENERGY RECOVERY UNIT AND METHOD OF USE

(71) Applicant: The Curators of the University of Missouri, Columbia, MO (US)

(72) Inventors: Hongbin Ma, Columbia, MO (US); Tahmid Hasan Rupam, Columbia, MO (US)

(21) Appl. No.: 19/085,806

(22) Filed: Mar. 20, 2025

Related U.S. Application Data
(60) Provisional application No. 63/567,733, filed on Mar. 20, 2024.

(51) Int. Cl. F26B 23/00

(52) U.S. Cl. CPC F26B 23/005; F26B 2210/16

(57) ABSTRACT

A system for drying a wood product includes a vessel defining a chamber, a condenser for providing heat in the vessel, a compressor that directs pressurized fluid to the condenser, a dehumidifier that recovers thermal energy from the chamber, an energy storage tank that stores heat transfer fluid, an evaporator heat exchanger that transfers thermal energy from the heat transfer fluid to the condenser, a pump that directs the heat transfer fluid from the tank to the dehumidifier and the evaporator heat exchanger, and an oscillating heat pipe (OHP). The OHP has a first portion upstream of the dehumidifier relative to airflow for circulating about the wood product and configured to precool air passing through the first portion to the dehumidifier, and a second portion downstream of the dehumidifier relative to the airflow and configured to preheat air passing from the dehumidifier.

### CROSS-REFERENCE TO RELATED APPLICATIONS

The present application is a non-provisional application that claims priority benefit of U.S. Provisional Application Ser. No. 63/567,733; entitled “HEAT PIPE DRYER WITH AN OSCILLATING HEAT PIPE ENERGY RECOVERY UNIT (OHP-ERU) AND ASSOCIATED METHOD OF USE”; and filed Mar. 20, 2024. The Provisional Application is hereby incorporated by reference, in its entirety, into the current application.

### BACKGROUND OF THE INVENTION

Conventional wood drying processes are plagued by high operational costs, primarily due to inefficient heating practices. Conventional wood product driers generally use fossil fuels and/or other combustible materials to generate heat for drying the wood product. For example, conventional driers generally rely on on-site gas furnaces for around three-quarters of heating energy. However, combustion processes are inherently energy inefficient with an efficiency range of around 20-60%, often resulting in suboptimal energy utilization. This pronounced energy expenditure not only strains operational budgets but also exacerbates environmental concerns by driving excessive carbon emissions. As a consequence, conventional drying processes amplify the environmental footprint of the lumber industry, thereby negatively impacting sustainability targets.

Thus, there is a need for improved wood product drying systems and processes. This background discussion is intended to provide information related to the present invention which is not necessarily prior art.

### SUMMARY OF THE INVENTION

Embodiments of the current invention address one or more of the above-mentioned problems and provide a distinct advance in the art of wood product drying systems and methods.

One embodiment of the invention is a system for drying a wood product. The system includes a vessel, a condenser, a compressor, a dehumidifier, an energy storage tank, an evaporator heat exchanger, a pump, and an oscillating heat pipe (OHP). The vessel defines a chamber for containing the wood product. The condenser provides heat in the vessel. The compressor is in fluid communication with the condenser and is configured to direct pressurized fluid to the condenser. The dehumidifier is configured to remove moisture and recover thermal energy from within the chamber and includes a condensation output. The energy storage tank is in fluid communication with the condensation output and is operable to store the thermal energy with a heat transfer fluid. The evaporator heat exchanger is in fluid communication with the condenser and the energy storage tank and is configured to transfer thermal energy in the heat transfer fluid to the fluid from the condenser. The pump is configured to direct the heat transfer fluid from the energy storage tank to the dehumidifier and the evaporator heat exchanger.

The OHP includes a first portion upstream of the dehumidifier relative to airflow circulating about the wood product and a second portion that is downstream of the dehumidifier relative to the airflow. The first portion is configured to precool air passing through the first portion to the dehumidifier, and the second portion is configured to preheat air passing from the dehumidifier. The thermal energy recovered by the OHP and dehumidifier through both the latent and sensible heats is efficiently transferred to the energy storage tank at a very small temperature difference resulting in a minimized entropy production or maximizing the energy reutilization. Additionally, the thermal energy for the evaporator heat exchanger is provided by heat transfer fluid at an elevated temperature from the energy storage tank, which directly raises the evaporator heat exchanger temperature and significantly improves the condenser's coefficient of performance. Further, the system enables elevated drying temperature to fully leverage the physical properties of water moisture to efficiently and uniformly dry the wood product. The comparatively higher temperature also allows for shorter drying times as air can contain more moisture at elevated temperatures, and superheated steam allows for faster heat transfer. The heating cycle of the system does not necessitate a high-level vacuum, thereby significantly reducing system costs. Thus, the system enables precise and uniform heating and dehumidification of the wood product, thereby producing high quality, bend-and crack-free, light-colored wood product.

Another embodiment of the invention is a method of drying wood product. The method includes circulating, via an airflow source, air within a chamber containing the wood product; heating, via a condenser, the circulating air; directing, via a compressor, pressurized fluid to the condenser; absorbing, via a dehumidifier and an oscillating heat pump (OHP), thermal energy from the circulating air; storing, via an energy storage tank, condensation and heat transfer fluid from the dehumidifier and heat transfer fluid from an evaporator heat exchanger; transferring, via the evaporator heat exchanger, thermal energy in the heat transfer fluid to the fluid from the condenser; and directing, via a pump, the heat transfer fluid from the energy storage tank to the dehumidifier and the evaporator heat exchanger.

A system according to another embodiment of the invention includes a vessel, a condenser, a compressor, a dehumidifier, an energy storage tank, an evaporator heat exchanger, and a pump. The vessel defines a chamber for containing the wood product. The condenser provides heat in the vessel. The compressor is in fluid communication with the condenser and is configured to direct pressurized fluid to the condenser. The dehumidifier is configured to recover thermal energy from within the chamber and includes a condensation output. The energy storage tank is in fluid communication with the condensation output and is operable to store a heat transfer fluid. The evaporator heat exchanger is in fluid communication with the condenser and is positioned inside the energy storage tank. The evaporator heat exchanger is configured to transfer thermal energy in the heat transfer fluid in the energy storage tank to the fluid from the condenser. The pump is configured to direct the heat transfer fluid from the energy storage tank to the dehumidifier.

A method according to another embodiment of the invention includes circulating, via an airflow source, air within a chamber containing the wood product; heating, via a condenser, the circulating air; directing, via a compressor, pressurized fluid to the condenser; absorbing, via a dehumidifier, thermal energy from the circulating air after the circulating air passes around the wood product; storing, via an energy storage tank, condensation and heat transfer fluid from the dehumidifier; transferring, via an evaporator heat exchanger submerged in the heat transfer fluid in the energy storage tank, thermal energy in the heat transfer fluid to the fluid from the condenser; and directing, via a pump, the heat transfer fluid from the energy storage tank to the dehumidifier.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a schematic diagram depicting selected components of a system for drying wood product according to an embodiment of the present invention;

FIG. 2 is a perspective view of an oscillating heat pipe (OHP) of the system of FIG. 1;

FIG. 3 is a schematic diagram depicting selected components of a system for drying wood product according to another embodiment of the present invention in which an evaporator heat exchanger is located in a storage tank;

FIG. 4 is a schematic diagram depicting selected components of a system for drying wood product using a vapor-compression-ejector cycle according to another embodiment of the present invention;

FIG. 5 is a schematic diagram depicting selected components of a system for drying wood product including a U-shaped OHP according to another embodiment of the present invention;

FIG. 6 is a schematic diagram depicting selected components of a system for drying wood product including a two-part OHP according to another embodiment of the present invention;

FIG. 7 is a flowchart depicting exemplary steps of a method according to an embodiment of the present invention;

FIG. 8 is a flowchart depicting exemplary steps of a method according to another embodiment of the present invention; and

FIG. 9 is a sectional view of the U-shaped OHP and dehumidifier of the system depicted in FIG. 5 according to an embodiment of the present invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

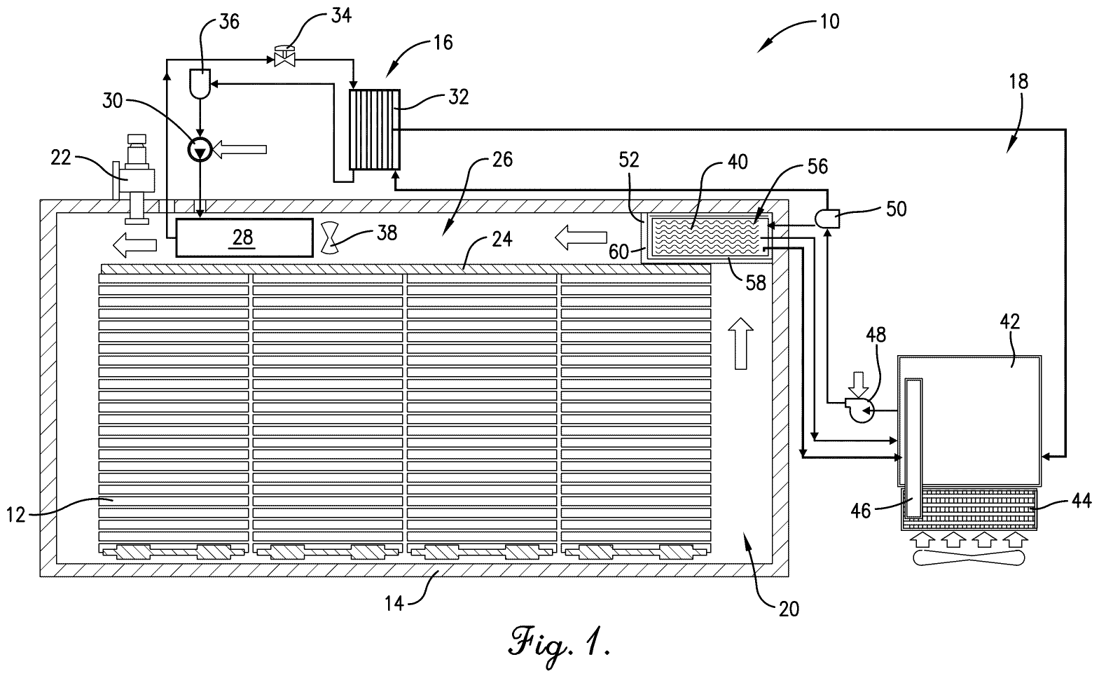

Turning to FIG. 1, a system 10 constructed according to an embodiment of the invention is schematically depicted. The system 10 is configured to dry wood product 12, such as lumber, wood chips, hardwood, etc. The system 10 may be entirely electrically driven using the components described herein. In one or more embodiments, the system 10 comprises a vessel 14, a heat pump 16, and an energy recovery and storage unit 18.

The vessel 14 defines a chamber 20 for containing the wood product 12. In one or more embodiments, the chamber 20 is thermally insulated and substantially airtight. In one or more embodiments, the vessel 14 further comprises one or more pressure relief valves (PRVs) 22 in fluid communication with the chamber 20 and configured to allow airflow from inside the chamber 20 to outside the chamber 20 when pressure inside the chamber is above a threshold. This enables the system 10 to have excellent thermal insulation and airtightness while not necessitating a high-level vacuum, thereby significantly reducing system costs. Since the system 10 operates as a closed system, pressure naturally increases with temperature or moisture percentage, so the PRV 22 manages chamber pressure. In one or more embodiments, when the internal pressure exceeds atmospheric pressure, the PRV 22 opens, thereby allowing excess air to escape the chamber 20 until the system 10 reaches a steady state, at which point the PRV 22 closes. The vessel 14 may include one or more internal walls 24 to define an airflow path that goes through the wood product 12 and through one or more channels 26 in which portions of the heat pump 16 and energy recovery and storage unit 18 are located.

The heat pump 16 provides heat within the vessel 14 for drying the wood product 12. In one or more embodiments, the heat pump 16 comprises a condenser 28, a compressor 30, an evaporator heat exchanger 32, an expansion valve 34, one or more flow control devices 36, and one or more airflow sources 38. The condenser 28 transfers thermal energy of the heat pump 16 into the airflow circulating in the vessel 14. In one or more embodiments, the condenser 28 comprises a microchannel refrigerant vapor condenser. The condenser 28 may be located in the chamber 20 of the vessel 14 along the airflow path in the channel 26 so that the air passing through the condenser 28 is heated and directed to the wood product 12. The condenser 28 is in fluid communication with the compressor 30 and receives pressurized fluid therefrom. In one or more embodiments, the high-pressure fluid comprises a refrigerant, such as a low global warming potential (GWP) hydrofluoroolefin (HFO) refrigerant, such as HFO-1234yf, HFO-1233zd, or the like. The output of the condenser 28 is in fluid communication with the expansion valve 34.

The compressor 30 is in fluid communication with the condenser 28 and is configured to pressurize fluid received from the evaporator heat exchanger 32 and direct the pressurized fluid to the condenser 28. As used herein, “pressurized fluid” or “high-pressure fluid” discussed in relation to the compressor 30 is fluid that is at a higher pressure than the pressure of the fluid that the compressor 30 receives at its input from the evaporator heat exchanger 32. In one or more embodiments, the compressor 30 is electrically driven. The compressor 30 receives the fluid from the evaporator heat exchanger 32 and converts it to high-pressure vapor.

The evaporator heat exchanger 32 is in fluid communication with the condenser 28 and the energy recovery and storage unit 18. The evaporator heat exchanger 32 is configured to transfer thermal energy in the heat transfer fluid to the fluid from the condenser 28. The thermal energy for the evaporator heat exchanger 32 is provided by the heat transfer fluid at an elevated temperature from the energy recovery and storage unit 18, which directly raises the evaporator temperature and significantly improves the coefficient of performance (COP) of the heat pump 16. The heat transfer fluid from the energy recovery and storage unit 18 causes the heat pump 16 to stay at an elevated temperature. The elevated temperature minimizes the entropy production, or in other words, it maximizes the energy re-utilization. The elevated drying temperature also better leverages the physical properties of water moisture to efficiently and uniformly dry the wood product. The comparatively higher drying temperature ensures shorter drying times as air can contain more moisture at elevated temperatures, thereby producing precise and uniform heating or dehumidification of the wood product 12 and high quality, bend-and crack-free, light-colored wood product 12.

The expansion valve 34 is in fluid communication with the condenser 28 and the evaporator heat exchanger 32. The expansion valve 34 receives the high-pressure heated liquid from the condenser 28, converts it to low-pressure heated liquid, and directs it to the evaporator heat exchanger 32.

The flow control device 36 is connected in series between the evaporator heat exchanger 32 and the compressor 30. In one or more embodiments, the flow control device 36 is configured to control a flow rate of the fluid from the evaporator heat exchanger 32 to the compressor 30 and also control the power to the compressor 30.

The airflow source 38 may comprise a fan, a pressurized air source, a pump, blower, or the like, and is configured to circulate air in the chamber 20. For example, the airflow source 38 may be configured to direct airflow through the channel 26 so that it flows through the condenser 28 where it is heated and then flows through the wood product 12.

The energy recovery and storage unit 18 is configured to recover heat in the chamber 20 and provide energy to the evaporator heat exchanger 32 of the heat pump 16. The energy recovery and storage unit 18 comprises a dehumidifier 40, an energy storage tank 42, a heat exchanger 44, a thermal diode 46, one or more pumps 48, one or more flow control device 50, and an oscillating heat pipe (OHP) 52. The dehumidifier 40 is configured to recover thermal energy from within the chamber and includes a condensation output in fluid communication with the energy storage tank 42. In one or more embodiments, the dehumidifier 40 is located in the chamber 20 of the vessel 14 so that airflow passing from the wood product 12 flows toward the dehumidifier 40. The dehumidifier 40 contains thermal transfer fluid from the tank 42, which is at a lower temperature than the air circulating in the chamber 20. The dehumidifier 40 removes some of the heat in the chamber to the lower temperature thermal transfer fluid, which causes some of the moisture in the heated air in the chamber 20 to condense. The dehumidifier 40 is configured to collect the condensed moisture and direct it to the tank 42 through the condensation output.

The energy storage tank 42 is in fluid communication with the condensation output of the dehumidifier 40 and the evaporator heat exchanger 32. The tank 42 stores the heat transfer fluid as a thermal energy storage medium. In one or more embodiments, the heat transfer fluid comprises water. This stored fluid serves a dual purpose: (1) recovering both the latent and the sensible heats from inside the drying chamber 20 while functioning as an effective cooling tower for the dehumidifier 40, and (2) providing energy at an elevated temperature to the heat pump evaporator heat exchanger 32, which significantly increase the heat pump 16 COP.

The heat exchanger 44 is configured to provide heat to the thermal diode 46. The heat exchanger 44 may be configured to receive heat from an external source, such as a fan 54 configured to direct heated and/or ambient air toward the heat exchanger 44.

The thermal diode 46 is configured to transfer heat to the heat transfer fluid in the energy storage tank 42. The thermal diode 46 may be thermally coupled to the heat exchanger 44. In one or more embodiments, the thermal diode 46 comprises a heat pipe thermosyphon that transfers unidirectional thermal energy to the heat transfer fluid in the tank 42 when the ambient temperature is higher than the storage temperature.

The pump 48 is configured to direct the heat transfer fluid from the energy storage tank 42 to the dehumidifier 40, the evaporator heat exchanger 32, and the OHP 52. The heat transfer fluid flow control device 50 is in fluid communication with the pump 48 and is configured to receive the heat transfer fluid and direct it to the dehumidifier 40, the evaporator heat exchanger 32, and the OHP 52. The flow control device 50 may be connected in series between the pump 48 and the dehumidifier 40 and the evaporator heat exchanger 32.

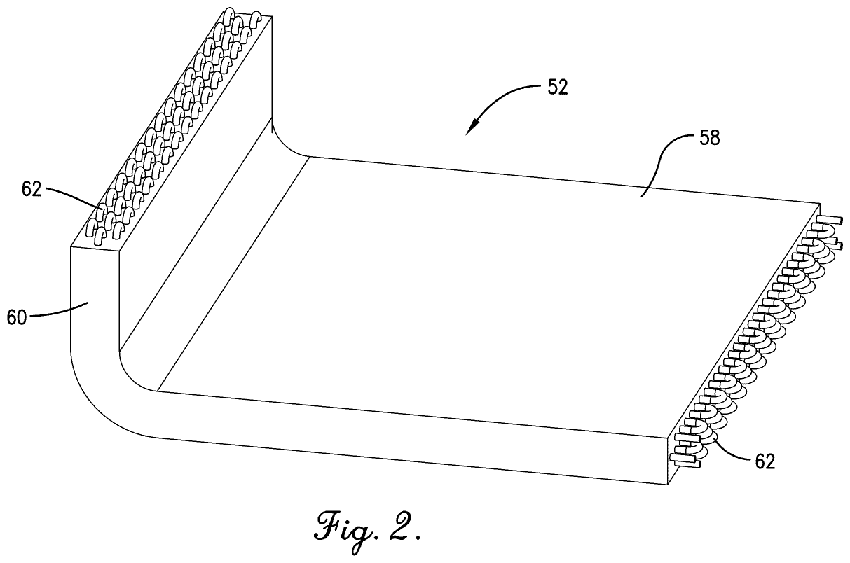

The OHP 52 precools and preheats the upstream and downstream air passing therethrough. The OHP 52, also referred to as a pulsating heat pipe, is only partially filled with the heat transfer fluid, or liquid working fluid. An exemplary OHP is described and depicted in U.S. Pat. No. 12,104,854, which is hereby incorporated by reference herein. In one or more embodiments, the OHP 52 also acts as a moisture condenser and directs the moisture back to the tank 42. The OHP 52 may be in fluid communication with the pump 48 and the tank 42 so that it receives heat transfer fluid from the pump 48 and then directs the heat transfer fluid back to the tank 42. In one or more embodiments, the OHP 52 is L-shaped and helps define a cavity 56 with the vessel 14 inside the chamber 20 in which the dehumidifier 40 is located. The OHP 52 may include a first portion 58 upstream of the dehumidifier 40 relative to the airflow circulating about the wood product 12 and a second portion 60 downstream of the dehumidifier 40 relative to the airflow. The first portion 58 is configured to precool air passing therethrough to the dehumidifier 40. The second portion 60 is configured to preheat air passing from the dehumidifier 40 and back to the condenser 28. Turning to FIG. 2, the OHP 52 comprises one or more pipes 62 arranged in a serpentine pattern in which freely moving liquid and vapor segments alternate. The one or more pipes 62 extend between the first portion 58 and the second portion 60.

The thermal energy (both the latent and sensible heat) recovered by the dehumidifier 40 and the OHP 52 will be efficiently transferred to the tank 42 at a very small temperature difference resulting in a minimized entropy production or maximize the energy reutilization. In one or more embodiments, the tank 42 self-regulates the drying conditions based on automatic sensing of the temperature (T), relative humidity (RH), and the remaining moisture content (RMC) to ensure optimized energy usage. In one or more embodiments, one or more control systems may be implemented to regulate the drying conditions based on automatic sensing of the ration of temperature and relative humidity less the remaining moisture content (T/RH-RMC). The energy recovery and storage unit 18 therefore effectively and efficiently recovers both latent and sensible heat to further increase the system thermal efficiency and significantly reduce the heat losses. The use of the superheated steam by the system 10 efficiently and uniformly heats and dries the wood product 12, thereby ensuring faster heat transfer that will drastically shorten drying times.

In one or more embodiments, the evaporator heat exchanger 32 and the dehumidifier 40 comprise compact exchangers, which enable the system 10 to be integrable to existing energy-intensive, greenhouse gas emitting fossil fuel based drying kilns to make them environmentally benign and sustainable.

In use, during drying, the hot moist air heated by the condenser 28 flows through the void spaces in between wood product 12 stacks. Heat is transferred from the air to the wood product 12. The saturation pressure of the moisture in the wood product 12 rises. Water is transferred from the wood product 12 to the air under the saturation pressure potential difference. The air now closer to saturation is cooled by the heat transfer fluid at the dehumidifier 40 and OHP 52 where the excess moisture condenses, thereby releasing the heat of condensation. The heat transfer fluid transfers this latent heat from the dehumidifier 40 and OHP 52 to the tank 42, thereby ensuring efficient latent heat recovery. Additionally, the condensate leaving the dehumidifier 40 at a higher temperature is passed to the tank 42, thereby recovering the sensible heat and its available heat to the tank 42, and the cycle continues until the wood product 12 is sufficiently dried.

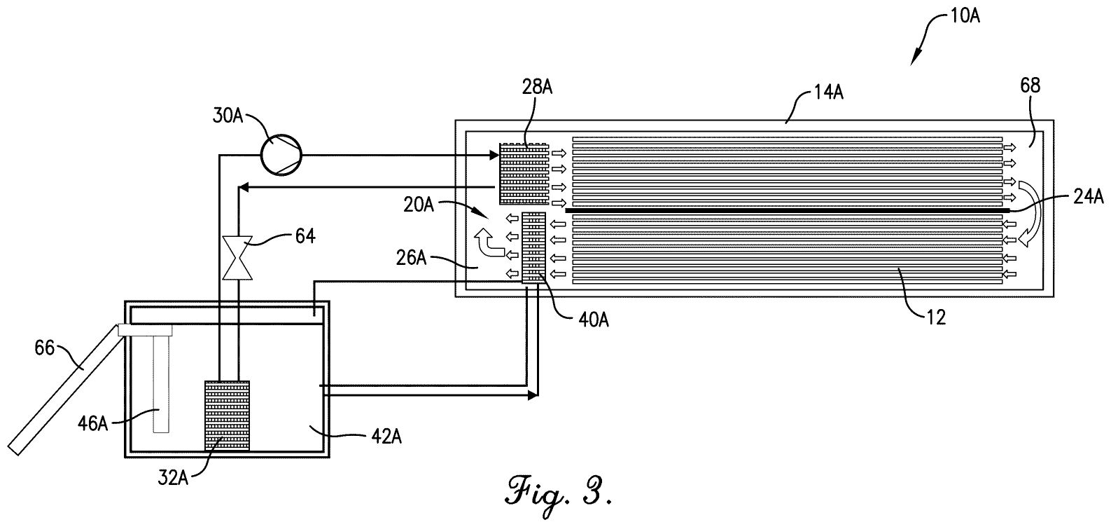

A system 10A constructed in accordance with another embodiment of the invention is shown in FIG. 3. The system 10A may comprise substantially similar components as system 10; thus, the components of system 10A that correspond to similar components in system 10 have an ‘A’ appended to their reference numerals.

The system 10A includes substantially similar features of system 10 except that the evaporator heat exchanger 32A is positioned inside the energy storage tank 42A, and further comprises an expansion valve 64 in fluid communication with condenser 28A and the evaporator heat exchanger 32A and a solar collector 66 thermally coupled to the thermal diode 46A, which transfers thermal energy from the collector 66 to the heat transfer fluid in the tank 42A. The evaporator heat exchanger 32A is configured to transfer thermal energy from the heat transfer fluid to the fluid from the condenser 28A. The one or more pumps (not depicted) are configured to direct the heat transfer fluid to the dehumidifier 40A. Additionally, the internal wall 24A is located in the vessel 14A to form a first channel 26A in which the condenser 28A and the dehumidifier 40A are located and a second channel 68 in which air flows from the wood product 12 on one side of the internal wall 24A (e.g., above the wall 24A) to the other side of the internal wall 24A (e.g., below the wall 24A). The airflow source (not depicted) may be located in either of the channels 26A, 68 for circulating the air within the chamber 20A. While FIG. 3 depicts the solar collector 66 for providing external heat to the tank 42A, any type of thermal energy source may be used without departing from the scope of the present invention.

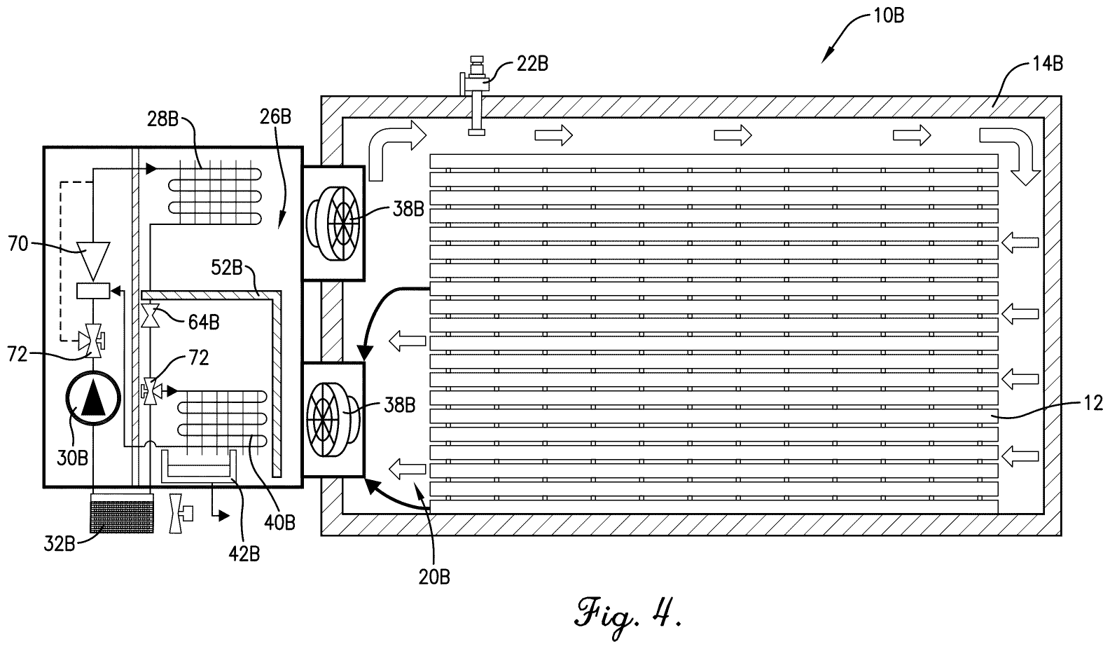

A system 10B constructed in accordance with another embodiment of the invention is shown in FIG. 4. The system 10B may comprise substantially similar components as systems 10, 10A; thus, the components of system 10B that correspond to similar components in systems 10, 10A have a ‘B’ appended to their reference numerals.

The system 10B includes substantially similar features of systems 10, 10A except that the system 10B uses a vapor-compression-ejector cycle and does not use an energy storage tank for storing thermal energy. The tank 42B of the system 10B is used merely for collecting condensate from the dehumidifier 40B. The system 10B comprises a vessel 14B with a first chamber 20B housing the wood product 12 and a second chamber 26B housing the condenser 28B and the dehumidifier 40B, a pair of fans 38B for circulating the air between the chambers 20B, 26B, a compressor 30B that directs fluid from the evaporator heat exchanger 32B to an ejector 70, which entrains additional thermal energy from the dehumidifier 40B and supplies high-pressure fluid to the condenser 28B. The system 10B may also include an expansion valve 64B that receives high-pressure fluid form the condenser 28B and outputs low pressure fluid to the evaporator heat exchanger 32B and the dehumidifier 40B. The system 10B may also include one or more three-way valves 72 for controlling flow of the fluid.

In use, the compressor 30B generates high-pressure refrigerant vapor, which, together with the thermal energy from the dehumidifier 40B and OHP 52B, powers the ejector 70. The compressed vapor traverses through the condensed refrigerant ejector 70 and entrains the additional thermal energy from the dehumidifier 40B. This combined refrigerant stream flow into the microchannel condenser 28B, where the refrigerant vapor condenses and transfers thermal energy through the microchannel condenser 28B to the circulating hot air with water vapor. The circulating fans 38B are activated, initiating an increase in temperature within the first chamber 20B (for example at 80° C.). As the fans operate, hot air containing water vapor or water vapor circulates throughout the chamber 20B, permeating the vacant spaces, including the gaps between stacks of wood product 12. The rising temperature leads to an increase in saturation pressure within the chamber 20B. Simultaneously, the moist wood product 12 starts to release moisture into the chamber 20B, thereby saturating it with water vapor once more. Meanwhile, the saturated water vapor encounters the dehumidifier 40B and the OHP 52B, where some of vapor condenses and releases thermal energy to the dehumidifier 40B and the OHP 52B. The OHP 52B is installed so that the evaporator section of the OHP 52B is upstream of the dehumidifier 40B and the condenser section of the OHP 52B is downstream.

The OHP 52B efficiently transfers heat, with its evaporator (hot side) and condenser (cold side) sections. The incoming hot steam (e.g., at 80° C.) interacts with the evaporator side of the OHP 52B, transferring heat and raising the temperature of the condenser section (e.g., to 74° C.). The desired steam temperature leaving the dehumidifier 40B and OHP 52B depends on the steam flow rate, drying time, and wood product moisture content. As the hot vapor cools upon contact with the cold surface of the dehumidifier 40B (e.g., reaching 68° C.), condensation takes place. The resulting condensate may be collected via gravity on a tray 42B beneath the dehumidifier 40B before moving to a water reservoir. The cooled steam then passes through the condenser section of the OHP 52B, recovering sensible heat. Simultaneously, the heat of condensation from the moisture at the evaporator coil is utilized for evaporating refrigerant within the ejector 70, contributing to the latent heat recovery. This helps to remove the moisture in the chamber 20B and efficiently recover the thermal energy and to further increase the system COP. The rest of the water vapor in the circulating air flows through the condenser 28B where the water vapor is heated up and becomes the superheated vapor. The superheated water vapor flows through wood product 12. In doing so, the superheated water vapor heats up the wood product 12, and moisture released from the wood product 12 is added to the water vapor stream. And the water vapor stream becomes saturated again. This cycle continues until the desired dehumidification of the wood product 12 is achieved.

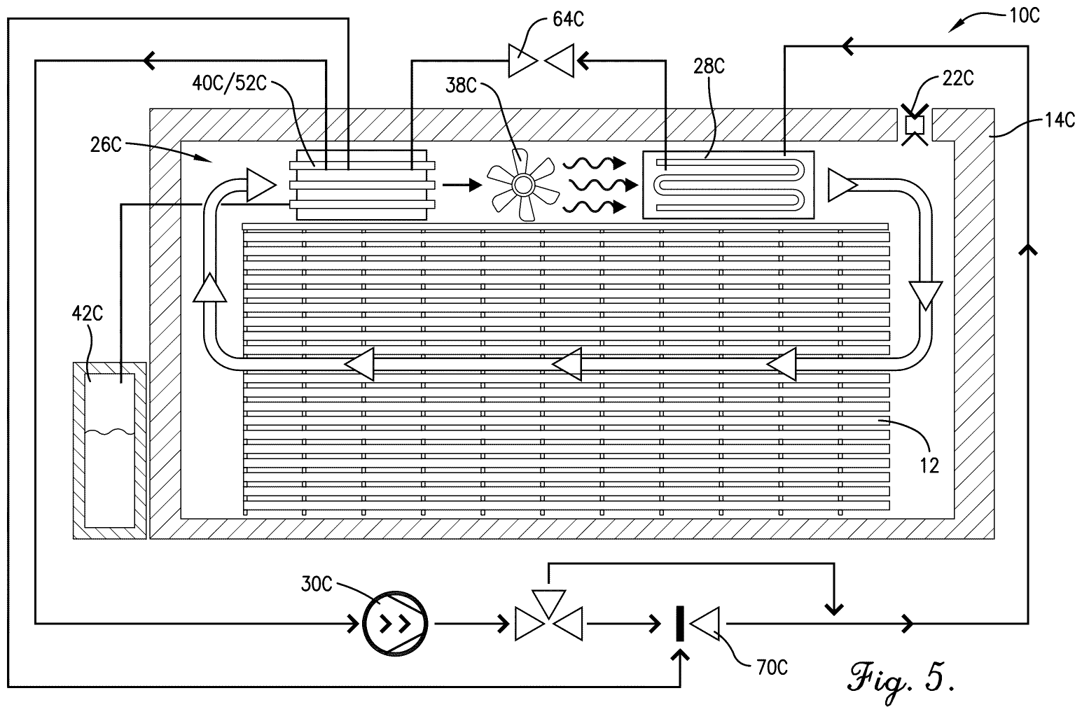

A system 10C constructed in accordance with another embodiment of the invention is shown in FIG. 5. The system 10C may comprise substantially similar components as systems 10, 10A, 10B; thus, the components of system 10C that correspond to similar components in systems 10, 10A, 10B have a ‘C’ appended to their reference numerals.

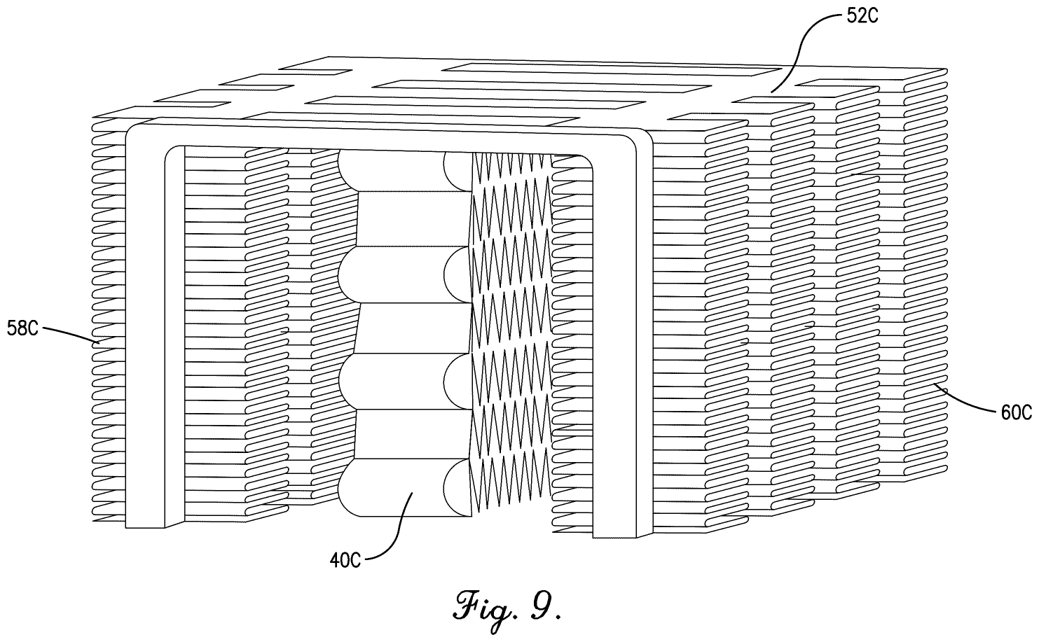

The system 10C includes substantially similar features of systems 10, 10A, 10B except that the dehumidifier 40C and OHP 52C perform the function of the evaporator heat exchanger. The condenser 28C receives the high-pressure fluid from the ejector 70C and compressor 30C, which receive low pressure fluid from the dehumidifier 40C and OHP 52C. The ejector 70C also receives heated fluid from the dehumidifier 40C. The system 10C further includes an expansion valve 64C that receives high-pressure fluid from the condenser 28C and outputs low pressure fluid to the dehumidifier 40C. In one or more embodiments, the OHP 52C comprises a U-shaped OHP with the first portion 58C (for precooling) upstream of the dehumidifier 40C in the channel 26C and the second portion 60C (for preheating) downstream of the dehumidifier 40C in the channel 26C (as depicted in FIG. 9). A fan or blower 38C may be positioned between the dehumidifier/OHP 40C, 52C and the condenser 28C in the channel 26C.

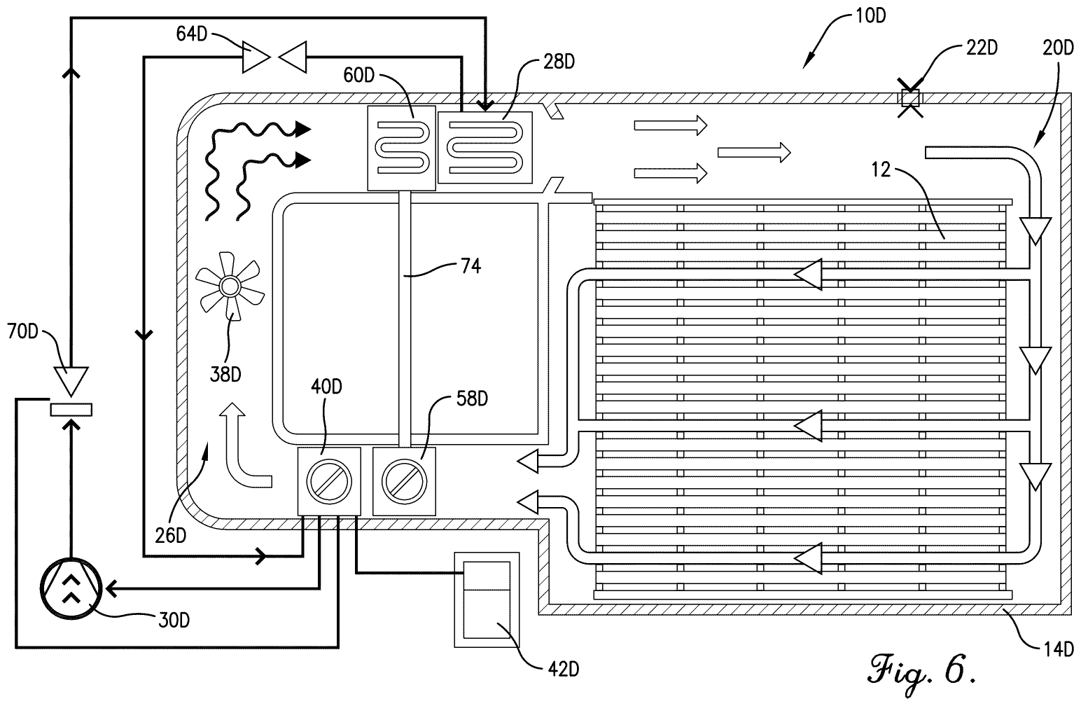

A system 10D constructed in accordance with another embodiment of the invention is shown in FIG. 6. The system 10D may comprise substantially similar components as systems 10, 10A, 10B, 10C; thus, the components of system 10D that correspond to similar components in systems 10, 10A, 10B, 10C have a ‘D’ appended to their reference numerals.

The system 10D includes substantially similar features of systems 10, 10A, 10B, 10C except that the second portion 60D of the OHP 52D (for preheating) is located adjacent or proximal to the condenser 28D, and the first portion 58D of the OHP 52D (for precooling) is located proximal or adjacent the dehumidifier 40D with the first and second portions 58D, 60D being connected via a conduit 74. The airflow source 38D circulates air around the channel 26D and the chamber 20D. The air is preheated by the second portion 60D of the OHP 52D and then heated by the condenser 28D. The heated air flows into the chamber 20D and about the wood product 12. The air then flows back into the channel 26D through the first portion 58D of the OHP 52D where it is precooled. It then passes through the dehumidifier 40D. Heat captured by the first portion 58D is used to preheat the air in the second portion 60D. The condensation heat captured by the dehumidifier 40D is used to help vaporize the high-pressure fluid at the ejector 70D. The compressor 30D receives fluid from the dehumidifier 40D, and directs pressurized fluid to the ejector 70D. The high-pressure fluid from the ejector 70D is supplied to the condenser 28D. An expansion valve 64D receives the fluid from the condenser 28D and outputs lower pressure fluid to the dehumidifier 40D. Water moisture condensation from the dehumidifier 40D is collected at the condensation tank 42D.

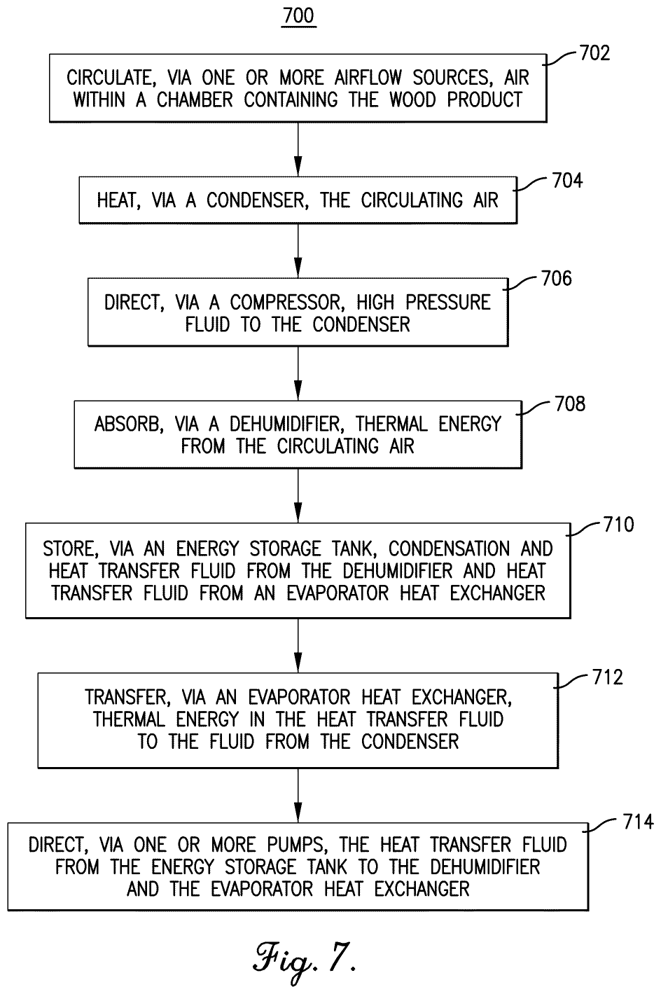

The flow chart of FIG. 7 depicts the steps of an exemplary method 700 of drying a wood product. In some alternative implementations, the functions noted in the various blocks may occur out of the order depicted in FIG. 7. For example, two blocks shown in succession in FIG. 7 may in fact be executed substantially concurrently, or the blocks may sometimes be executed in the reverse order depending upon the functionality involved. In addition, some steps may be optional. The method 700 is described below, for ease of reference, as being executed by exemplary devices and components introduced with the embodiments illustrated in FIGS. 1-6.

Referring to step 702, air within a chamber of a vessel is circulated via one or more airflow sources. The chamber houses the wood product for drying. The airflow source may be a fan, blower, pressurize nozzle, air compressor, or the like. The airflow source may be positioned within a channel of the vessel or external thereto and in fluid communication with the chamber.

Referring to step 704, the circulating air is heated via a condenser. This step may include receiving at the condenser pressurized fluid, such as a vapor refrigerant. The condenser may be in the chamber and/or located in a channel in fluid communication with the chamber and through which the circulating air flows. This step may include preheating the circulating air via a condenser portion of an OHP. The condenser portion may preheat the circulating air before it passes through the condenser.

Referring to step 706, high-pressure fluid is directed to the condenser via a compressor. In one or more embodiments, the compressor directs high-pressure fluid to an ejector, which entrains the fluid with additional energy captured via a dehumidifier. The flow rate from the compressor may be controlled via one or more flow control devices.

Referring to step 708, the dehumidifier absorbs at least a portion of the thermal energy from the circulating air. A first portion of an OHP may precool the circulating air before it flows to the dehumidifier and after the circulating air passes through the wood product. The dehumidifier may include piping with heat transfer fluid flowing therethrough that is at a lower temperature than the circulating air so that moisture in the circulating air condenses and is collected by the dehumidifier and directed to the energy storage tank. The energy captured as a result of the condensation is transferred to the heat transfer fluid and also directed to the energy storage tank. After the circulating air passes through the dehumidifier, this step may include preheating such air via the second portion of the OHP downstream of the dehumidifier relative to the circulating air. The energy for the preheating of the circulating air may be provided by fluid flowing from the first portion of the OHP to the second portion.

Referring to step 710, the condensation and heat transfer fluid from the dehumidifier and heat transfer fluid from an evaporator heat exchanger are stored via the energy storage tank. This step may include reheating the heat transfer fluid and condensation via one or more external heat sources. For example, one or more solar collector, a combustion heat source, or the like may be used to generate and/or collect thermal energy for providing to the heat transfer fluid in the tank. The heat may be transferred to the heat transfer fluid via one or more thermal diodes and/or one or more heat exchangers.

Referring to step 712, thermal energy in the heat transfer fluid is transferred, via the evaporator heat exchanger, to the fluid from the condenser. The thermal energy is then directed to the energy storage tank, which adds thermal energy to the heat transfer fluid stored therein.

Referring to step 714, the heat transfer fluid from the energy storage tank is directed, via one or more pumps, to the dehumidifier and the evaporator heat exchanger. The heat transfer fluid may be heated to an elevated temperature relative to the fluid/refrigerant from the condenser and directed to the evaporator heat exchanger.

The method 700 may include additional, less, or alternate steps and/or device(s), including those discussed elsewhere herein.

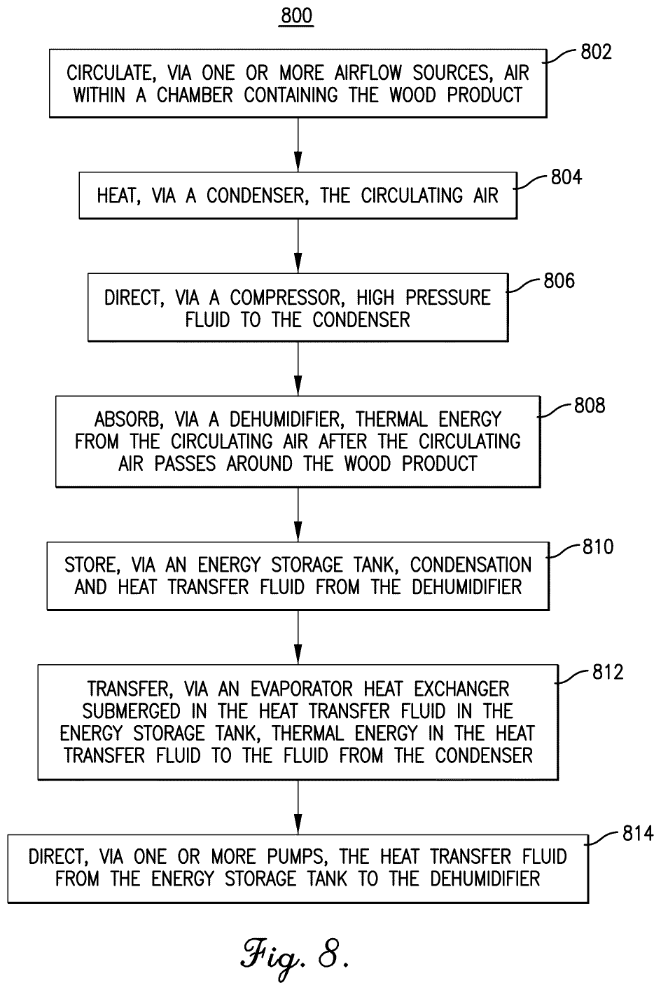

The flow chart of FIG. 8 depicts the steps of an exemplary method 800 of drying a wood product according to another embodiment of the invention. In some alternative implementations, the functions noted in the various blocks may occur out of the order depicted in FIG. 8. For example, two blocks shown in succession in FIG. 8 may in fact be executed substantially concurrently, or the blocks may sometimes be executed in the reverse order depending upon the functionality involved. In addition, some steps may be optional. The method 800 is described below, for ease of reference, as being executed by exemplary devices and components introduced with the embodiments illustrated in FIGS. 1-6.

Referring to step 802, air within the chamber containing the wood product is circulated via one or more airflow sources. The airflow sources may be positioned in the chamber, in one or more channels of the vessel in fluid communication with the chamber, and/or in one or more channels external to the vessel that are in fluid communication with the chamber.

Referring to step 804, the circulating air is heated via the condenser. This step may include receiving at the condenser pressurized fluid, such as a vapor refrigerant. The condenser may be in the chamber and/or located in a channel in fluid communication with the chamber and through with the circulating air flows. This step may include preheating the circulating air via a condenser portion of an OHP. The condenser portion may preheat the circulating air before it passes through the condenser.

Referring to step 806, high-pressure fluid is directed, via the compressor, to the condenser. In one or more embodiments, the compressor directs high-pressure fluid to an ejector, which entrains the fluid with additional energy captured via a dehumidifier. The flow rate from the compressor may be controlled via one or more flow control devices.

Referring to step 808, thermal energy from the circulating air is absorbed, via the dehumidifier, after the circulating air passes around the wood product. A first portion of an OHP may precool the circulating air before it flows to the dehumidifier and after the circulating air passes through the wood product. The dehumidifier may include piping with heat transfer fluid flowing therethrough that is at a lower temperature than the circulating air so that moisture in the circulating air condenses and is collected by the dehumidifier and directed to the energy storage tank. The energy captured as a result of the condensation is transferred to the heat transfer fluid and also directed to the energy storage tank. After the circulating air passes through the dehumidifier, this step may include preheating such air via the second portion of the OHP downstream of the dehumidifier relative to the circulating air. The energy for the preheating of the circulating air may be provided by fluid flowing from the first portion of the OHP to the second portion.

Referring to step 810, condensation and heat transfer fluid from the dehumidifier is stored in the energy storage tank. This step may include reheating the heat transfer fluid and condensation via one or more external heat sources, such as for example, one or more solar collector, a combustion heat source, or the like. The heat may be transferred to the heat transfer fluid via one or more thermal diodes extending into the tank and/or one or more heat exchangers in thermal communication with the thermal diode.

Referring to step 812, thermal energy in the fluid from the condenser is transferred, via the evaporator heat exchanger submerged in the heat transfer fluid in the energy storage tank, to the heat transfer fluid. The fluid (e.g., refrigerant) from the compressor releases heat energy via the condenser and is then directed to the evaporator heat exchanger. The fluid is at an elevated temperature relative to the heat transfer fluid; therefore, its thermal energy is released into the heat transfer fluid as it passes through the evaporator heat exchanger submerged in the heat transfer fluid in the tank.

Referring to step 814, the heat transfer fluid is directed, via one or more pumps, from the energy storage tank to the dehumidifier.

The method 800 may include additional, less, or alternate steps and/or device(s), including those discussed elsewhere herein.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

Furthermore, unless otherwise specified, any directional references (e.g., upper, lower, above, below, etc.) are used herein solely for the sake of convenience and should be understood only in relation to each other. For instance, a component might in practice be oriented such that faces referred to as “upper” and “lower” are sideways, angled, inverted, etc. relative to the chosen frame of reference.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A system for drying a wood product, the system comprising:
a vessel defining a chamber for containing the wood product;
a condenser for providing heat in the vessel;
a compressor in fluid communication with the condenser and configured to direct pressurized fluid to the condenser;
a dehumidifier configured to recover thermal energy from within the chamber and including a condensation output;
an energy storage tank in fluid communication with the condensation output and operable to store a heat transfer fluid;
an evaporator heat exchanger in fluid communication with the condenser and the energy storage tank and configured to transfer thermal energy in the heat transfer fluid to the fluid from the condenser;
one or more pumps configured to direct the heat transfer fluid from the energy storage tank to the dehumidifier and the evaporator heat exchanger; and
an oscillating heat pipe (OHP) having a first portion upstream of the dehumidifier relative to airflow circulating about the wood product and configured to precool air passing through the first portion to the dehumidifier, and a second portion downstream of the dehumidifier relative to the airflow and configured to preheat air passing from the dehumidifier.

2. The system of claim 1, wherein the OHP is L-shaped and helps define a cavity with the vessel inside the chamber, and the dehumidifier is located in the cavity.

3. The system of claim 1, further comprising one or more airflow sources configured to circulate air about the condenser, the chamber, the dehumidifier, and the OHP.

4. The system of claim 1, further comprising a pressure relief valve in fluid communication with the chamber and configured to allow airflow from inside the chamber to outside the chamber when pressure inside the chamber is above a threshold.

5. The system of claim 1, further comprising a thermal diode configured to transfer heat to the heat transfer fluid in the energy storage tank, a heat exchanger configured to provide heat to the thermal diode, and a fan configured to direct heated air toward the heat exchanger.

6. The system of claim 1, wherein the pressurized fluid comprises a refrigerant.

7. The system of claim 6, wherein the refrigerant comprises at least one of HFO-1234yf or HFO-1233zd.

8. The system of claim 1, further comprising an expansion valve in fluid communication with the condenser and the evaporator heat exchanger.

9. The system of claim 1, further comprising one or more flow control devices connected in series between the evaporator heat exchanger and the compressor, and one or more heat transfer fluid flow control devices connected in series between the one or more pumps and the dehumidifier and the evaporator heat exchanger.

10. The system of claim 1, further comprising an ejector where high-pressure vapor from the compressor can entrain additional thermal energy into the system to further increase a coefficient of performance (COP) of the system.

11. A method of drying a wood product, the method comprising:
circulating, via one or more airflow sources, air within a chamber containing the wood product;
heating, via a condenser, the circulating air;
directing, via a compressor, pressurized fluid to the condenser;
absorbing, via a dehumidifier and an oscillating heat pump (OHP), thermal energy from the circulating air;
storing, via an energy storage tank, condensation and heat transfer fluid from the dehumidifier and heat transfer fluid from an evaporator heat exchanger;
transferring, via the evaporator heat exchanger, thermal energy in the heat transfer fluid to the fluid from the condenser; and
directing, via one or more pumps, the heat transfer fluid from the energy storage tank to the dehumidifier and the evaporator heat exchanger.

12. The method of claim 11, wherein the OHP has a first portion upstream of the dehumidifier relative to the circulating air and configured to precool the circulating air passing through the first portion to the dehumidifier, and a second portion downstream of the dehumidifier relative to the circulating air and configured to preheat the circulating air passing from the dehumidifier.

13. The method of claim 11, wherein the absorbing, via the dehumidifier, the thermal energy from the circulating air includes absorbing, via the dehumidifier, the thermal energy from the circulating air after the circulating air passes through the wood product.

14. The method of claim 13, wherein the heating, via the condenser, the circulating air includes heating, via the condenser, the circulating air after the circulating air passes through the dehumidifier.

15. The method of claim 11, further comprising transferring, via a thermal diode, thermal energy from a heat source to the energy storage tank.

16. A system for drying a wood product, the system comprising:
a vessel defining a chamber for containing the wood product;
a condenser for providing heat in the vessel;
a compressor in fluid communication with the condenser and configured to direct pressurized fluid to the condenser;
a dehumidifier configured to recover thermal energy from within the chamber and including a condensation output;
an energy storage tank in fluid communication with the condensation output and operable to store a heat transfer fluid;
an evaporator heat exchanger in fluid communication with the condenser and positioned inside the energy storage tank and configured to transfer thermal energy in the heat transfer fluid in the energy storage tank to the fluid from the condenser; and
one or more pumps configured to direct the heat transfer fluid from the energy storage tank to the dehumidifier.

17. The system of claim 16, further comprising an expansion valve in fluid communication with condenser and the evaporator.

18. The system of claim 16, further comprising an oscillating heat pipe configured to precool air upstream of the dehumidifier and to preheat air downstream of the dehumidifier.

19. The system of claim 16, further comprising thermal diode configured to direct heat to the heat transfer fluid in the energy storage tank, and a solar collector thermally coupled to the thermal diode.

20. A method of drying a wood product using the system of claim 16, the method comprising:
circulating, via one or more airflow sources, air within the chamber containing the wood product;
heating, via the condenser, the circulating air;
directing, via the compressor, pressurized fluid to the condenser;
absorbing, via the dehumidifier, thermal energy from the circulating air after the circulating air passes around the wood product;
storing, via the energy storage tank, condensation and heat transfer fluid from the dehumidifier;
transferring, via the evaporator heat exchanger submerged in the heat transfer fluid in the energy storage tank, thermal energy in the heat transfer fluid to the fluid from the condenser; and
directing, via the one or more pumps, the heat transfer fluid from the energy storage tank to the dehumidifier.
